(19) United States
(12) Patent Application Publication
(10) Pub. No.: US 2017/0012775 A1
(43) Pub. Date: Jan. 12, 2017

(54) Encryption Methods and Apparatus

(71) Applicant: Philip J. Lafer, Blanchard, ID (US)

(72) Inventor: Philip J. Lafer, Blanchard, ID (US)

(21) Appl. No.: 14/883,506

(22) Filed: Oct. 14, 2015

Related U.S. Application Data
(60) Provisional application No. 62/065,553, filed on Oct. 17, 2014.

(51) Int. Cl. H04L 9/12

(52) U.S. Cl. CPC H04L 9/12

(57) ABSTRACT

Encryption methods and apparatus are described. According to one aspect, an encryption method includes accessing a sequence of an encryption base, the sequence comprising a plurality of sequence elements which correspond to different place values of the encryption base, accessing data to be encrypted, and using the sequence elements of the sequence, encrypting the data by converting the data from an initial base to the encryption base.

### RELATED PATENT DATA

This application claims the benefit of and priority to U.S. Provisional Patent Application Ser. No. 62/065,553, filed Oct. 17, 2014, and titled “Encryption System and Methods,” the disclosure of which is incorporated herein by reference.

### TECHNICAL FIELD

This disclosure relates to encryption methods and apparatus.

### BACKGROUND OF THE DISCLOSURE

Modern day life is increasingly reliant upon electronic data, for example, which may be stored in databases and communicated, using wireless communications in one example. However, as recent events have illustrated, electronic data may be subject to interception or hacking by sophisticated parties who are not authorized to obtain, access or view the data.

At least some aspects of the present disclosure are directed to apparatus and methods which encrypt and decrypt data which may be stored, communicated or used for other purposes.

### BRIEF DESCRIPTION OF THE DRAWINGS

Example embodiments of the disclosure are described below with reference to the following accompanying drawings.

FIG. 1 is a block diagram of an encryption system according to one embodiment.

FIG. 2 is a block diagram of a computing system according to one embodiment.

FIG. 3 is a flow chart of a method of configuring a plurality of participants which encrypt and/or decrypt data according to one embodiment.

FIG. 4 is a flow chart of a method of encrypting data according to one embodiment.

FIG. 5 is a flow chart of a method of decrypting data according to one embodiment.

### DETAILED DESCRIPTION OF THE DISCLOSURE

This disclosure is submitted in furtherance of the constitutional purposes of the U.S. Patent Laws “to promote the progress of science and useful arts” (Article 1, Section 8).

At least some aspects of the present disclosure are directed to apparatus and methods which encrypt and decrypt data. In some embodiments, encryption systems and methods of the disclosure enable enhanced security by providing several ways that encryption can be changed at any identifiable time such as between messages or even within a long message in illustrative examples with a number of variations which can be tailored to different users. Methods and/or apparatus of the disclosure may be used independently to implement security or as additional security, such as a pre-encryption system, with other encryption methods and/or apparatus, such as a conventional two prime private domain encryption system.

Different encryption bases are used to encrypt and decrypt data in example embodiments discussed below. At least some aspects of the disclosure are directed to creation of a plurality of different encryption bases which may be used for encryption at different times for enhanced security and which make hacking the underlying data more difficult. Additional aspects of the encryption process apart from the encryption bases themselves may also be varied to further increase security of the underlying data as described below.

Encryption may be used in communications systems to encrypt data prior to communication to reduce the chances that the encrypted data will be compromised and the encrypted data may be decrypted following communication. These examples are illustrative and the methods and apparatus of the present disclosure may be utilized in any application or system where encryption of data is desired. In another illustrative example, encryption and decryption operations of the present disclosure may be used with respect to stored data where the data is encrypted prior to storage and decrypted following storage. Some example applications of use of the encryption systems and methods include use as an independent system for storing valuable data, as a private system within a company or between two or more business partners, or possibly as a security block to bank accounts or personal data or perhaps drone systems.

In some embodiments, encryption and decryption operations may be performed by different devices. In another embodiment, encryption and decryption operations may be implemented by the same device, for example, encryption of data may be performed prior to storage of the data and the stored encrypted data may be subsequently decrypted using the same device, for example, to retrieve and access the data.

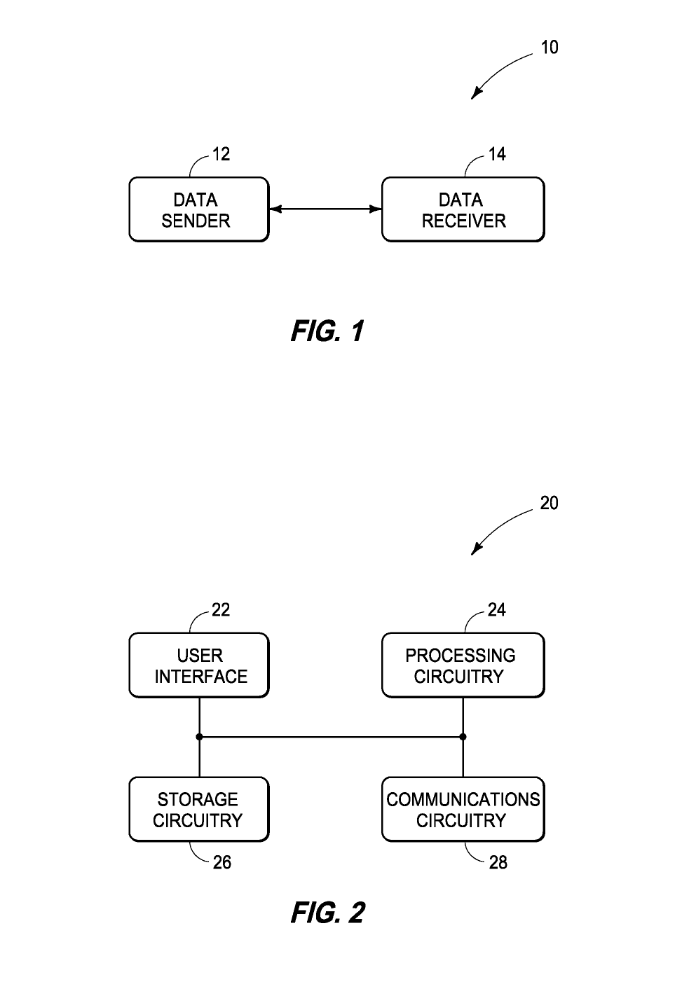

An example encryption system 10 is shown in FIG. 1 and which includes a data sender 12, and a data receiver 14. In one implementation, each of data sender 12 and data receiver 14 are implemented as a computing system, such as a personal computer, workstation, notebook computer, portable device (e.g., smartphone), etc. Details of an example computing system are described below with respect to FIG. 2.

In but one example, the data sender 12 and data receiver 14 may be remotely located devices and encrypted data may be communicated from sender 12 to receiver 14 via wired and/or wireless communications. The data sender 12 may encrypt the data before communication and data received 14 may decrypt the data which is received to access the data.

Aspects of the disclosure may be used in any other arrangement to encrypt and/or decrypt data. In another illustrative example, data sender 12 may be a source of data, such as a computing device, and data receiver 14 may be a storage entity, such as a database, for storing the data. In a more specific example, the data sender 12 encrypts the data and communicates the encrypted data to data receiver 14 for storage. Thereafter, sender 14 may retrieve and decrypt the encrypted data from data receiver 14.

Referring to FIG. 2, one embodiment of a computing system 20 is shown. In the illustrated example embodiment, computing system 20 includes a user interface 22, processing circuitry 24, storage circuitry 26, and communications circuitry 28. Other embodiments of computing system 20 are possible including more, less and/or alternative components.

User interface 22 is configured to interact with a user including conveying data to a user (e.g., displaying visual images for observation by the user) as well as receiving inputs from the user. For example, data to be encrypted may be selected via user interface 22 of an encrypting device and specifics of the encryption may be selected. In addition, the user interface 22 of a receiving device may be utilized to display data following decryption of the data.

In one embodiment, processing circuitry 24 is arranged to process data, control data access and storage, issue commands, and control other desired operations. Processing circuitry 24 may comprise circuitry configured to implement desired programming provided by appropriate computer-readable storage media in at least one embodiment. For example, the processing circuitry 24 may be implemented as one or more processor(s) and/or other structure configured to execute executable instructions including, for example, software and/or firmware instructions. Other example embodiments of processing circuitry 24 include hardware logic, PGA, FPGA, ASIC, state machines, and/or other structures alone or in combination with one or more processor(s). These examples of processing circuitry 24 are for illustration and other configurations are possible. In one embodiment, the processing circuitry 24 is configured via appropriate executable instructions to perform encryption and/or decryption operations discussed herein.

Storage circuitry 26 is configured to store programming such as executable code or instructions (e.g., software and/or firmware), electronic data, databases, image data, or other digital information and may include computer-readable storage media. At least some embodiments or aspects described herein may be implemented using programming stored within one or more computer-readable storage medium of storage circuitry 26 and configured to control appropriate processing circuitry 24.

The computer-readable storage medium may be embodied in one or more articles of manufacture which can contain, store, or maintain programming, data and/or digital information for use by or in connection with an instruction execution system including processing circuitry 24 in one embodiment. For example, computer-readable storage media may be non-transitory and include any one of physical media such as electronic, magnetic, optical, electromagnetic, infrared or semiconductor media. Some more specific examples of computer-readable storage media include, but are not limited to, a portable magnetic computer diskette, such as a floppy diskette, a zip disk, a hard drive, random access memory, read only memory, flash memory, cache memory, and/or other configurations capable of storing programming, data, or other digital information.

Communications circuitry 28 is arranged to implement communications of computing system 20 with respect to external devices (not shown). For example, communications circuitry 28 may be arranged to communicate information bi-directionally with respect to computing system 20. For example, communications circuitry 28 may communicate information bi-directionally with respect to computing system 20 and include hardware for wired connections (e.g., network interface card (NIC), serial or parallel connections, USB port, Firewire interface), and/or circuitry for wireless connections (e.g., Bluetooth, Cellular, GPS, WiFi, etc.).

A plurality of encryption bases are used to encrypt data in one embodiment. The encryption of the data may be continuously varied to enhance the security of the encryption, for example, by using different encryption bases. In addition, other aspects of the encryption process may additionally be varied to offer even greater security. The encryption bases being used to encrypt the data are also used to decrypt the encrypted data in some embodiments. At least some aspects of the disclosure are directed towards generation and use of a plurality of encryption bases to encrypt data as well as additional aspects of the encryption process.

In some example embodiments described further below, changes to the encryption bases are facilitated by a further generalization of Dr. George Cantor's 1869 generalization of the polynomial base ten (and base b for b≧2) systems. These changes create a plurality of different encryption bases for use in data encryption in one embodiment. Cantor viewed our base ten representation of a real number R=cₙ . . . c₂ c₁c₀. d₁d₂ . . . dₖ as a shortcut notation for the polynomial c 10ⁿ+ . . . +c₂10²+c₁10+c₀+d₁/10+d₂/10²+ . . . +dₖ/10^{k}. He further envisioned this as based upon the sequence S= [symbol] . . . , 10, 10, 10, 10, 10, 10, 1, 10, 10, 10, 10, 10, 10, . . . [symbol] where natural number place values are the product of the elements (i.e. 10's and decimal place values are their reciprocals). The digit multipliers are restricted to 0≦cᵢ≦9 and 0≦dᵢ≦9. He then investigated using sequences as a base for similar polynomial form number systems where place values are again the product of the elements, but the elements are not all the same size.

The notation for his sequences is [symbol] = [symbol] . . . , m₃, m₂, m₁, 1, m₁, m₂, m₃ . . . [symbol] with m₁≧2. The place value notations for whole numbers are M₀=1 and for i≧1, M₁=mᵢ·mᵢ₋₁· . . . ·m₂·m₁. The digits for the Mᵢ place values are restricted to 0≦d≦mᵢ₋₁−1. Cantor showed that every real number could be uniquely represented using any such sequence.

In some embodiments of the disclosure, natural numbers are used in the encryption system as described in the following examples. Other embodiments are possible.

If [symbol] = [symbol] . . . ,3,5,7,6,2,5,4,3,1,3,4,5,2,6,7,5,3, . . . [symbol] , the first few natural number place values are: 1, 3, 4·3=12, 5·4·3=60, 2·5·4·3=120, 6·2·5·4·3=720, 7·6·2·5·4·3=5040, . . . .

The first 17 whole numbers written in this base [symbol] are: 0=0=0(1), 1=1=1(1), 2=2=2(1), 3=10=1(3)+0(1), 4=11 =1(3)+1(1), 5=12=1(3)+2(1), 6=20=2(3)+0(1), 7=21=2(3)+1(1), 8=22=2(3)+2(1), 9=30=3(3)+0(1), 10=31 =3(3)+1(1), 11=32=3(3)+2(1), 12=100=1(12)+0(3)+0(1), 13=101=1(12)+0(3)+1(1), 14=102=1(12)+0(3)+2(1), 15=110=1(12)+1(3)+0(1), 16=111=1(12)+1(3)+1(1), 17=112=1(12)+1(3)+2(1) and a larger example 4123=540321=5(720)+4(120)+0(60)+3(12)+2(3)+1(1).

According to example embodiments of the disclosure, a further generalization of Cantor's generalization as discussed below allows the elements in the sequence to the right of the “1” to be different from those on the left. Such sequences are referred to as master sequences which may be used to generate a plurality of different subsequences which correspond to different encryption bases during encryption operations described below according to one embodiment. The subsequences individually have a finite length which is less than the length of the master sequence in one embodiment. In one implementation, the maximum size of the sequence elements of the master sequences is a power of two for straightforward compatibility with base two utilized by computers. Master sequences may also be referred to as Lafer sequences.

The discussion proceeds with respect to the creation of master sequences according to example embodiments. More specifically, in one embodiment, an initial sequence such as [symbol] = [symbol] s₁, s₂, . . . , s₂ₖ, s₂ₖ₊₁, . . . s_{4K} [symbol] with sequence elements constrained by 2≦s₁≦2ⁿ for some n≧3 is provided and the sequence element 1 is inserted somewhere between sₖ and s₃ₖ to create a first master sequence (e.g., [symbol] ₀= [symbol] ₁= [symbol] s₁, . . . , sₖ . . . sⱼ, 1, sⱼ₊₁ . . . s₃ₖ, . . . , s₄ₖ [symbol] ) which includes a plurality of natural numbers in an order including only a single occurrence of the number 1.

With these example guidelines, there are almost 4k useable additional master sequences which are obtained by simply moving the element 1 right or left in the initial sequence. Moving the sequence element 1 one space left gives another master sequence [symbol] ₋₁= [symbol] s₁, s₂, . . . . sⱼ₋, 1, sⱼ, . . . , s_{4K} [symbol] . In one embodiment, every move of the 1 in the initial sequence creates a new master sequence. As described further below, the different master sequences may be used to generate different subsequences [symbol] of different encryption bases for encryption in one embodiment. In several ways the sequence element 1 acts like the decimal point in base ten in this example.

In one embodiment, data to be encrypted may be divided into a plurality of message blocks of any length of data, and the encrypted lengths are the product LB where L is the element length (i.e., the number of sequence elements in the subsequence used) and B is the number of base two digits used to convert the [symbol] subsequence digits to base two form. This is three or more digits and usually less than or equal to eight in one embodiment. Individual messages blocks may include data or content corresponding to a single keystroke of a keyboard input device or other single input in one embodiment. One or more encryption parameters may be changed for each message block (e.g., 8, 16, 32, 64, 128 bits) as discussed below according to illustrative embodiments. Accordingly, each of the individual message blocks may be encrypted differently in some embodiments. Alternatively, data objects including a plurality of characters, such as words, numbers, etc., may be encrypted in a single message block. Any data which is represented numerically may be encrypted using the apparatus and methods of the disclosure.

For use of the disclosed embodiments as pre-encryption to a private domain base two system, encrypted lengths are powers of two so L and B are also powers of two in one implementation. For independent system or storage applications, the lengths can be any number of bits which is divisible by 3 or 4 or 5 or 6 in one embodiment. The encrypted blocks are usually at least 50% longer than the message blocks. If there is a need to have the encrypted blocks be a specific small length like 64 bits, a shorter message block system, like 32 bits, may be used. Use of the disclosed encryption system for pre-encrypting with a private domain system, 64 bit message blocks of data can be encrypted to get 128 or larger powers of 2 bit encryptions and 128 bit message blocks of data can be encrypted to get 256 or larger powers of 2 bit encryptions.

The following small examples demonstrate one embodiment of the encryption system. Note that the examples shown use base ten number conversions which would not be necessary for most system designers and computer programmers. The first few examples use the full master sequences (also referred to as Lafer sequences) which are modified in later examples.

Let an initial sequence [symbol] be a 56 element sequence with all sequence elements 2≦sᵢ≦8.

In one more specific example, let [symbol] = [symbol] 3,6,5,4,7,2,8,4,6,2,5,5,6,8,6, 4,7,7,3,4,6,8,3,7,5,5,2,5,4,8,3,7,6,5,4,3,8,6,7,5,3,6,7,2,8,3,4,8,5,6,7,3 [symbol] and insert a 1 to the right of the thirtieth sequence element which creates a first master or Lafer sequence [symbol] ₃₀= [symbol] 3,6,5,4,7,2,8,4,6,2,5,5,6,8,6,4,7,7,3,4,6,8,3, 7,5,5,2,5,4,8,1,3,7,6,5,4,3,8,6,7,5,3,6,7,2,8,3,4,8,5,6,7,3 [symbol] .

Let [symbol] ₀= [symbol] ₃₀. Moving the 1 four elements to the right creates a second master sequence S₃₄= [symbol] ₄ where the [symbol] ₄ is simpler notation which indicates the position of the number 1 in the second master sequence relative to the position of the number 1 in the first master sequence [symbol] ₀. Thus, [symbol] ₄= [symbol] 3,6,5,4,7,2,8,4,6,2,5,5,6,8,6,4,7,7,3,4,6,8,3,7,5,5,2,5,4,8,3,7,6,5, 1,4,3,8,6,7,5,3,6,7,2,8,3,4,8,5,6,7,3 [symbol] .

Moving the 1 four elements to the left creates a third master sequence S₂₆= [symbol] ₄ where the [symbol] ₄ indicates the position of the number 1 in the second master sequence relative to the position of the number 1 in the first master sequence [symbol] ₀. Thus, [symbol] ₄= [symbol] 3,6,5,4,7,2,8,4,6,2,5,5,6,8,6,4,7,7, 3,4,6,8,3,7,5,5,1,2,5,4,8,3,7,6,5,4,3,8,6,7,5,3,6,7,2,8,3,4,8,5,6,7,3 [symbol] .

The master sequences may be one of a plurality of different sequence types in one embodiment. The largest element [symbol] ₁ allowed in the different sequence types is a power of two in one embodiment. Unless the message or encrypted blocks are larger than 256 bits, there is no need to have more than four types. Four practical sequence types which may be used in one embodiment are:
(1) 2≦ [symbol] i≦8 are 0S8 types of sequences having a maximum size of elements of 8
(2) 2≦ [symbol] i≦16 are 1S6 types of sequences having a maximum size of elements of 16
(3) 2≦ [symbol] i≦32 are 3S2 types of sequences having a maximum size of elements of 32
(4) 2≦ [symbol] i≦64 are 6S4 types of sequences having a maximum size of elements of 64
Note: 2≦ [symbol] i≦4 may be used in some implementations but is small and may be relatively insecure.

Some examples of master sequences [symbol] ₀'s in each of these four types are:
(1) [symbol] . . . ,3,6,5,4,7,2,8,4,6,2,5,5,6,8,6,4,7,7,3,4,6,8,3,7,5,5,2,5,4,8,1,3,7,6,5,4, 3,8,6,7,5,3,6,7,2,8,3,4,8,5,6,7,3, . . . [symbol]
(2) [symbol] . . . ,05,11,03,08,06,15,15,02,04,09,10,07,10,14,13,1,08,11,13,14,04,06, 09,16,12,03,09,05,07,14, . . . [symbol]
(3) [symbol] . . . ,11,19,23,23,22,05,09,27,22,16,10,04,18,09,1,02,05,13,18,21,19,17, 20,30,31,06,25,04,07, . . . [symbol]
(4) [symbol] ,62,03,18,13,44,18,58,52,33,16,38,21,10,05,14,1,10,06,49,41,56,05, 18,26,19,04,51,18, . . .

[symbol]

Encryption may be implemented using bases other than base 2 in other embodiments. For example, it may be desired to use bases b other than base 2 and these other bases can be used in other implementations. However, in these embodiments, there is only one SL subsequence for each base b since moving the 1 does not change anything. The encryption codes may be changed between or within communications in these described embodiments.

Message blocks M of X bits of data to be encrypted can vary from all 0's to all 1's in an example binary system, so if treated as base two numbers, their values range from 0 to (2^{x}−1). The sequence elements and subsequence element length L (i.e., number of elements in the subsequence) are chosen so that the largest message blocks can be written in any subsequence base [symbol] ᵢ (also referred to as an encryption base) in one embodiment. This is discussed in further detail below.

In one embodiment, encryption may begin after the master sequence [symbol] ₀, subsequence [symbol] ᵢ, the message size (X bits) and B (the number of base two digits used to convert base [symbol] ᵢ digits to base two form) have all been generated or selected.

In one embodiment, the encryption performs the following acts where base ten notations and values between base two and base SL conversions are used to facilitate understanding of one example embodiment of the encrypting system. Computer programmers will convert directly between base two form of bit blocks and base SL numbers and digits in some embodiments in accordance with desired encryption parameters, such as bit block size to keep encrypted blocks the desired length.

A: The message to be encrypted is a plurality of data message blocks of X bits with each block treated as a base two, X digit number;

B: Continue the encryption process by converting the base two numbers to L digit subsequence base [symbol] ᵢ numbers and apply any security changes (such as addends) to each (i.e., conversion from an initial base to the encryption base);

C: Convert each of the encryption base [symbol] ᵢ digits to B bit base two form blocks; and

D: String all L of the B bit blocks together for an LB encrypted block. Then, string the plurality of these encrypted BL bit blocks together for the final encrypted message which may be stored, communicated, etc.

Additional details of the encryption process are discussed below. The following examples illustrate how to encrypt a 24 bit message block using several variations of the sequence (1) above and two examples of each type (2), (3) and (4) sequences. Each will produce different encrypted blocks including varying lengths.

For a 24 bit block of data to be encrypted with the sequence (1) of type 0S8, the subsequences used (in these examples) will have a 1 and 12 sequence elements and produce 12 digit base [symbol] numbers in one embodiment. The subsequences start with 1 on the right end followed by the first 11 elements to the left of the 1 in the [symbol] ᵢ sequence followed by the assigned element 8 (the largest possible element allowed in a type [symbol] sequence) so the subsequences have 13 characters. The 12 place values are 1 and the 11 element products left of the 1. The last assigned element 8 determines that the digit multiplier of the 12th place value is the largest possible which produces the largest possible base [symbol] ᵢ number. Each of the 12 base [symbol] ᵢ digits are converted to 3 digit base two numbers. The 3 digits are minimum and can be more in other embodiments.

Let the 24 bit block of data to be encrypted be [symbol] =011110100001010111000101 in base two (which may be referred to as an initial base in this embodiment) and which is 8,000,965 in base ten and equals the 12 digit number 005716030005 in the encryption base using subsequence [symbol] ₀= [symbol] 8, 4, 6, 8, 3, 7, 5, 5, 2, 5, 4, 8, 1 [symbol] . Conversion between different bases is described in detail below. Converting each of these 12 digits of the encryption base to 3 digit base two numbers makes: 0=000, 0=000, 5=101, 7=111, 1=001, 6=110, 0=000, 3=011, 0=000, 0=000, 0=000, 5=101.

Stringing these base two bit forms together gives a 36 bit encryption: [symbol] ₀(0)=000000101111001110000011000000000101. Note that due to a small valued message and/or above average sized elements in the [symbol] ᵢ subsequence the first few base [symbol] ᵢ digits are often 0 which means the encryption starts with several 0 bits which for pre-encryption applications can be a security problem. This can be minimized in a couple of ways to increase the security of the encryption. One example way is by sequence and subsequence design.

Another way is by adding addends to the [symbol] ᵢ digits to increase the balance of different binary values of the data in one implementation. In one embodiment, addend A sizes are limited to 0≦A≦(2^{B}−1) where 0 is leave it alone. Any non-zero addend will help the excess 0 bit problem. Addends which have slightly more 1's than 0's in their base two form may be used in one embodiment.

In one embodiment, mod M arithmetic is used for the addition where the only numbers are whole numbers N with 0≦N≦M−1. In this system every multiple of M equals 0. For other natural numbers K, the K is divided by M and the remainder R is the mod M number. For negative integers K, divide K by M with a negative remainder R and (R+M) is the mod M number. Mod 8 is used in one encryption example so 0 through 7 are the only elements and the possible addend sums are: 0=0, 1=1, 2=2, 3=3, 4=4, 5=5, 6=6, 7=7, 8=0, 9=1, 10=2, 11=3, 12=4, 13=5 and 14=6.

Recall from above,
[symbol] ₀(0)=000000101111001110000011000000000101 with numerous 0 bits.

Using an addend of 3 mod 8 added to each of the 12 base [symbol] ₀ digits above, 005716030005 is changed to 330241363330. With these 12 digits converted to 3 digit base two numbers the result is:
011 011 000 010 100 001 011 110, 011 011 011 000 and
[symbol] ₀(3)=011011000010100001011110011011011000 a 36 bit encryption with an improved (increased) balance of 0 and 1 bits (more 1s) of the encrypted data compared with the result when the addend was not used. Another benefit to using and frequently changing addends during the encryption of information in accordance with some embodiments is that it is another way to change the encryption, thereby increasing security.

As mentioned above, the initial sequence may be changed at different times to change the master sequence and corresponding encryption bases which are used. In one example modification, the initial sequence (1) is changed by moving the 1 two spaces to the right gives [symbol] ₂= [symbol] 3,6,5,4,7,2,8,4,6,2,5,5,6,8,6,4,7,7,3,4,6,8,3,7,5,5,2,5,4,8,3,7,1,6,5,4,3, 8,6,7,5,3,6,7,2,8,3,4,8,5,6,7,3 [symbol] making the new subsequence [symbol] ₂= [symbol] 8, 8, 3, 7, 5, 5, 2, 5, 4, 8, 3, 7, 1 [symbol] .

Here the message block [symbol] =011110100001010111000101=020530110610 in base [symbol] ₂which in 3 digit base two form equals 000 010 000 101 011 000 001 001 000 110 001 000 for an encryption of [symbol] ₂(0)=000010000101011000001001000110001000.

Using an addend of 5 mod 8 changes 020530110610 to 575205665365 which in 3 digit base two form is 101 111 101 010 000 101 110 110 101 011 110 101 which gives an encryption with an increased number of 1's as shown.
[symbol] ₂(5)=101111101010000101110110101011110101

All of the above have encrypted blocks of 36 bits in this example as all used subsequence element lengths L=12 and the [symbol] digits were represented in B=3 digits.

Going back to the base L₀ example let each [symbol] ₀ digit be represented using a 4 (instead of 3) digit base two representation with addends mod 16 (instead of mod 8). This would change 005716030005 in [symbol] ₀ to 0000 0000 0101 0111 0001 0110 0000 0011 0000 0000 0000 0101 which as a string gives [symbol] (0)=000000000101011100010110000000110000 000000000101—a 48 bit encryption.

Using this four digit base two option with addends mod 16, an addend of 5 mod 16 changes 005716030005 to 05 05 10 12 06 11 05 08 05 05 05 10 which converted to 4 digit base two form is 0101 0101 1010 1100 0110 1011 0101 1000 0101 0101 0101 1010 which as a string is [symbol] ₀(5)=010101011010110001101011010110000101010101011010—a more balanced 0 and 1 bit encryption.

For three other examples of type sequences, the subsequences element length is 8. They will be formed by starting with 1 followed by the first 7 sequence elements to the left of the 1 followed by 16, 32 or 64—i.e. the largest allowable element for that type sequence.

Encrypting with type 1S6 sequence (2), [symbol] ₀= [symbol] . . . ,05,11,03,08,06,15, 15,02,04,09,10,07,10,14,13, 1,08,11,13,14,04,06,09,16,12,03,09,05,07,14, . . . [symbol] makes this subsequence [symbol] ₀= [symbol] 16, 04, 09, 10, 07, 10, 14, 13, 1).

Here the message block [symbol] =011110100001010111000101=01 02 08 08 00 01 04 11 in this base [symbol] ₀.

When each of these digits is converted to 4 digit base two form the result is 0001 0010 1000 1000 0000 0001 0100 1011 which as a string is [symbol] ₀(0)=00010010100010000000000101001011—a 32 bit encryption.

Using an addend of 7 mod 16 changes 01 02 08 08 00 01 04 11 to 08 09 15 15 07 08 11 02 (Note that 18=2 mod 16.) which in 4 digit base two form is 1000 1001 1111 1111 0111 1000 1011 0010 making [symbol] ₀(7)=10001001111111110111100010110010—a more balanced 0 and 1 bit encryption block.

Encrypting with type 3S2 sequence (3),
[symbol] ₀= [symbol] . . . ,11,19,23,23,22,05,09,27,22,16,10,04,18,09,1,02,05,13,18,21,19, 17,20 ,30,31, 06,25,04,07, . . . [symbol] makes this subsequence [symbol] ₀= [symbol] 32, 27, 22, 16, 10, 04, 18, 09, 1 [symbol] and [symbol] =011110100001010111000101=00 03 11 02 07 00 12 01 in this base S [symbol] ₀.

Converting these digits to a 5 digit base two form gives 00000 00011 01011 00010 00111 00000 01100 00001 making the 40 digit encryption [symbol] ₀(0)=0000000011010110001000111000000110000001—with numerous 0 bits.

Using an addend of 11 mod 32 changes 00 03 11 02 07 00 12 01 to 11 14 22 13 18 11 23 12.

Converting these digits to 5 digit base two form gives 01011 01110 10110 01101 10010 01011 10111 01100 which makes [symbol] ₀(11)=0101101110101100110110010010111011101100—an encryption block with an acceptable balance of 0 and 1 bits.

Encrypting with type 6S4 sequence (4), [symbol] ₀= [symbol] . . . ,62,03,18,13,44, 18,58,52,33,16,38,21,10,05,14,1,10,06,49,41,56,05,18,26,19,04,51,18, . . . [symbol] makes this subsequence [symbol] ₀= [symbol] 64, 33, 16, 38, 21, 10, 05, 14, 1 [symbol] .

Here the message block [symbol] =011110100001010111000101=00 00 14 12 05 09 02 07 in this base S [symbol] ₀ form.

The result of converting these digits to 6 digit base two form is 000000 000000 001110 001100 000101 001001 000010 000111 which makes this encryption
[symbol] ₀(0)=000000000000001110001100000101001001000010000111.

Using an addend of 15 mod 64 changes 00 00 14 12 05 09 02 07 to 15 15 29 27 20 24 17 22.

Converting these digits to 6 digit base two form gives 001111 001111 011101 011011 010100 011000 010001 010110 which as a string gives [symbol] ₀(15)=001111001111011101011011010100011000010001010110 a 48 bit encryption block with an acceptable balance of 0 and 1 bits.

As discussed in some example embodiments herein, data to be encrypted is converted from an initial base to one or more encryption bases.

There are two example ways to convert from base 10 to an encryption base which are described below. These two methods can be used to convert between any two polynominal form number systems. Other conversions may be used to convert the data from any desired base to the encryption base, for example, existing computing systems may convert from the data from base 2 to the encryption base in a straightforward manner. In another embodiment, the data in base 2 may be converted directly to the encryption base, or first converted to data in base 10 and then converted to the encryption base using the below example techniques.

Demonstrating in base ten with the first example (1) sequence above where 8,000,965 in base ten is converted to 005716030005 as a 12 digit number in encryption base [symbol] ₀= [symbol] 8, 4, 6, 8, 3, 7, 5, 5, 2, 5, 4, 8, 1 [symbol] .

The first example method is a top down method which finds the digit multiplier for the largest place value first and the digit multiplier for the smallest place value which is 1 last. Start by calculating the first twelve place values for this subsequence [symbol] ₀0.1 8, 4·8=32, 5·4·8=160, 2·5·4·8=320, 5·2·5·4·8=1600, 5·5·2·5 4·8=8000, 7·5·5·2·5·4·8=56,000, 3·7·5·5·2·5·4·8=168,000, 8·3·7·5·5·2·5·4·8=1,344,000, 6·8·3·7·5·5·2·5·4·8=8,064,000 and 4·6·8·3·7·5·5·2·5·4·8=32,256,000.

Start by dividing the largest place value 32,256,000 into the base ten number to be converted 8,000,965, getting a quotient of 0 and a remainder of 8,000,965. This quotient 0 is then the digit multiplier of the place value 32,256,000. Next divide the next place value 8,064,000 into the last remainder 8,000,965 again getting a quotient of 0 and remainder of 8,000,965 so the digit multiplier for this place value 8,064,000 is also 0 and the remainder is again 8,000,965. Then divide the next place value 1,344,000 into the last remainder 8,000,965 getting a quotient of 5 and a remainder of 1,280,965 so the digit multiplier for this place value 1,344,000 is 5. Then, divide the next place value 168,000 into the last remainder 1,280,965 getting a quotient of 7 and a remainder of 104,965 so the digit multiplier for this place value 168,000 is 7. Continue this way dividing 56,000 into the last remainder 104,965 getting a quotient of 1 and remainder of 48,965. Next 8000 is divided into the last remainder 48,965 getting a quotient of 6 and remainder of 965. Next 1600 is divided into 965 getting a quotient of 0 and remainder of 965. Next 320 is divided into 965 with a quotient of 3 and remainder of 5. Next 160 is divided into 5 with a quotient of 0 and remainder of 5. Next 32 is divided into 5 with a quotient of 0 and remainder of 5. Next 8 is divided into 5 with a quotient of 0 and remainder of 5. Finally 1 is divided into 5 with a quotient of 5 and remainder of 0. The number in this (1) encryption base [symbol] ₀ is the string of quotients 005716030005.

The second example conversion method from an initial base to an encryption base is a bottom up method where the digit multiplier of the smallest place value (which is 1) is found first and the largest place value digit is found last. With this method the place values are not needed and only the subsequence elements 8, 4, 6, 8, 3, 7, 5, 5, 2, 5, 4, 8, 1 of the encryption base are needed in one embodiment so the calculations are more straightforward.

Start by dividing the element 8 left of the 1 into 8,000,965 getting a quotient of 1,000,120 with a remainder of 5 which is the first digit (the units digit) for the converted number. Next, divide 4 (the 4 left of the last used 8) into the last quotient 1,000,120 getting a quotient of 250030 with a remainder of 0 which is the second digit. Next divide 5 into the last quotient 250,030 getting a quotient of 50,006 with a remainder of 0 which is the third digit. Next divide 2 into the last quotient 50,006 getting a quotient of 25,003 with a remainder of 0 which is the fourth digit. Continue this way dividing 5 into the last quotient 25,003 getting a quotient of 5000 with a remainder of 3. Divide 5 into the last quotient 5000 getting a quotient of 1000 with a remainder of 0. Divide 7 into the last quotient 1000 getting a quotient 142 with a remainder of 6. Divide 3 into the last quotient 142 getting a quotient of 47 with a remainder of 1. Divide 8 into the last quotient 47 getting a quotient of 5 with a remainder of 7. Divide 6 into the last quotient 5 getting a quotient of 0 with a remainder of 5. Divide 4 into the last quotient 0 with a remainder of 0. Finally, divide the last element 8 into the last quotient 0 getting a quotient of 0 with a remainder of 0 which is the last digit. The number in the encryption base [symbol] ₀ is the string of the 12 remainders 005716030005 in this example.

In one example encryption method discussed above, the digits of the encryption base may be subsequently converted to base two using a specified number of bits. These base two numbers may be strung together to provide the encrypted data for storage, communication, etc.

At least some aspects of the disclosure are directed towards decrypting the encrypted data. In one decryption embodiment, the information regarding the encryption of the data is used and the process is reversed for decryption. In particular, a decrypting device may access a plurality of encryption parameters which were used to perform the encryption and use the encryption parameters to perform decryption of encrypted messages.

In one embodiment, example encryption parameters which may be individually varied to increase security and provide additional encryption of the data include: message block size, [symbol] sequence, [symbol] ₀ sequence, SLᵢ subsequence, addend, the size of the base two conversion of the [symbol] digits, and schemes for how to change encryption parameters if and when you want.

For example, to decrypt the type 1S6 (2) encrypted message [symbol] ₀(7)=0001001111111110111100010110010 the decrypter uses information regarding the encryption parameters including that this 32 bit block was encrypted with the 8 element subsequence [symbol] ₀= [symbol] 16, 04, 09, 10, 07, 10, 14, 13, 1 [symbol] , using an addend of 7 mod 16, and each of the summed 8 digits were written in a 4 digit base two form in one illustrative example.

To decrypt the data, the encryption string is broken into eight 4 bit (summed+7 mod 16) blocks which are 1000 1001 1111 1111 0111 1000 1011 0010 as base two numbers. These numbers are: 08 09 15 15 07 08 11 02 in base ten.

When 7 (or 0111 in base two) is subtracted mod 16 from each of these, the results are: 01 02 08 08 00 01 04 11 (Note that −5=11 mod 16). These are the eight digits of the encryption base number and correspond to respective ones of the sequence elements (or place values) of the encryption base (e.g., subsequence) being utilized and which may be converted to base two, for example.

In particular, [symbol] ₀ number 1(4586400)+2(1146600)+8(127400)+8(12740)+0(1820)+1(182)+4(13)+11(1)=8000965 in base ten. This equals 011110100001010111000101 in base two which as a 24 bit block is the original message illustrating one example decryption method.

If addends are used to correct the imbalance of 0's and 1's (for example by increasing the number of 1s present), the addends occur in the beginning of each encryption message block which could help hackers trying to break the codes. Example embodiments are described below to address this situation to improve security further. For example, in one embodiment, the addend is frequently changed, for example, after every message block. Furthermore, as discussed below, the initial sequences may be designed to make the messages more difficult to hack.

The sequences which are used for encryption may be designed or selected according to various criteria to provide encryptions of increased security in example implementations discussed below. In some embodiments, it is desired to use sequences (and subsequences for conversions to the encryption bases) which are both safe and good.

A safe subsequence is one which can generate numbers as large as the base two value of a message block of all 1's. A safe sequence is one where all of its subsequences are safe so each subsequence does not need to be checked. For example, a 64 bit message of all 1's has a base two number equivalent of 2⁶⁴−1≅1.8446 . . . ×10¹⁹. To be considered safe, a 32 element SL subsequence generates a 32 digit number at least this large.

A good subsequence is a safe one where the digit multiplier of the largest place value in the SL subsequence number is greater than 0 for about half of the message blocks (those with 1 being the individual first bit).

A good sequence is one where all of its subsequences are good.

A 64 bit message block starting with the bit 1 followed by sixty-three 0's has a base two equivalent of 2⁶³ which is the smallest base two equivalence number of all message blocks starting with bit 1. Therefore, to be a good subsequence, the largest number that can be written using only the first 31 digits must be smaller than 2⁶³ ≅9.2233 . . . ×10¹⁸. This makes the 32^{nd} digit greater than 0 for all message blocks starting with bit 1.

One benefit in using good subsequences according to some of the described embodiments is that it minimizes an abundance of encryptions which start with B, 2B, or more 0's—where B is the number of base two digits used to represent the SL number digits as mentioned above.

Normal random sequences are usually, but not always, safe and often not good. Getting safe and good subsequences and sequences is easier when encrypting for private systems or storing important sensitive data where the length of the encryptions is not restricted to 64, 128 and/or other powers of two. Examples with the more challenging problem with pre-encryptions will be addressed first and the schemes used there can also be applied to the private system encryption.

The following examples using 64 bit message blocks encrypted into 128 bit encrypted blocks using 0S8 or 1S6 type sequences illustrate some schemes to obtain safe and good sequences. They are examples of the possible manipulations which can be used to accomplish this task. In one embodiment, 32 element SL subsequences and 4 digit base two representations of the SL base digits are used to encrypt 64 bit message blocks into respective 128 bit encryptions.

For these examples, first restrict the initial [symbol] sequence elements sᵢ to 2≦sᵢ≦7 as discussed above. Start with a block of the six numbers 2,3,4,5,6,7, such as 4,6,2,7,5,3 (there are 6·5·4·3·2·1=720 different such blocks). Arrange these 720 different blocks in a random order string forming a sequence S with 4320 elements. There are 144 different 30 element subsequences which can be formed out of each such sequence. A different random order of the six element blocks produces a different sequence with possibly some subsequence duplicates, but plenty of variety for good security. Form master sequences L₀ out of sequence [symbol] by inserting the number 1 between two blocks. For notational convenience, it is suggested to insert the 1 somewhere between the 1080^{th} and 3240^{th} elements of [symbol] ₀. These examples use 32 element subsequences with indices which are multiples of 6 (i.e., SL₆ₖ). The SL₆ₖ subsequences will start on the right with the number 1 followed by the first 30 elements to the left of the 1 (five full six element blocks), followed by the assigned elements 2 and then 8. This makes 32 element subsequences which generate the needed 32 digit SL numbers. So a typical 0S8 subsequence formed by moving the 1 eighteen elements to the left is SL₋₁₈= [symbol] 8, 2, [symbol] ₄₈, [symbol] ₄₇, . . . , [symbol] ₂₀, [symbol] ₁₉, 1 [symbol] .

The only difference with 1S6 type subsequences is that SL₋₁₈= [symbol] 16, 2, [symbol] ₄₈, [symbol] ₄₇, . . . , [symbol] ₂₀, [symbol] ₁₉, 1 [symbol] including the assigned elements 2 and 16 which is more versatile for pre-encryptions. The benefit of type [symbol] is that it allows for 3 digit base two representations of the SL digits which allows having encryption lengths different from a power of two including odd lengths.

In polynomial numeration systems (e.g., base b, Cantor or Lafer systems), the largest natural number that can be written with (k−1) digits is 1 less than the k^{th} place value (where 1 is the first place value). Like in base ten, the largest three digit number is 999 which is one less than 1000, the fourth place value. The example described sequence and subsequence design thus makes it possible to find the maximum number that can be written with these subsequence systems. It follows from the product of a block of these six elements 2·3·4·5·6·7=5040 that the product of the first 30 elements is 5040⁵≅3.2520 . . . ×10¹⁸. Denote this as SL(30) which for either type sequence is the place value for the thirty-first digit. Also, the place value for the thirty-second digit is 2SL(30). Therefore, the maximum numerical value of a 31 digit SL number is 2SL(30)−1≅6.5040 . . . ×10¹⁸<2⁶³≅9.2233 . . . ×10¹⁸ so the subsequences are good.

For 0S8 SL subsequences the thirty-third place value is 8˜2SL(30)=16SL(30). Therefore, the maximum number that can be generated from 0S8 SL subsequences is 16SL(30)−1≅5.2032 . . . ×10¹⁹ which is about three times larger than needed to be safe subsequences. For 1S6 type subsequences the thirty-third place value is 16·2SL(30)=32SL(30). Therefore, the maximum number that can be generated from 1S6 SL subsequences is 32SL(30)−1≅1.0406 . . .33 10²⁰ so also safe.

Even though the first digit is not 0, all the other digits will be less than 8 so using four digit base two representations of them will resort in a lot more 0 bits than 1 bits. Since everything that was done in 0S8 type sequences will work equally well in 1S6 types, it is desirable in some embodiments to use the 1S6 type sequences with more choices of addends and using mod 16 arithmetic. For example with 1S6 type the 0, 1, 2, 3, 4, 5, 6, 7 digits written in four digit base two form are: 0000, 0001, 0010, 0011, 0100, 0101, 0110, 0111. With an addend of 4 they become 4,5,6,7,8,9,10,11 in 1S6 type which in four digit base two form are 0100, 0101, 0110, 0111, 1000, 1001, 1010, 1011 which is improved balance of binary 0 and 1 bits.

Note that if the 1 is not placed between full six element blocks or the SL subsequence indices are not multiples of 6, the last half of one block and the first half of another could go together in a block. This could make a subsequence that looks like [symbol] 4,2,3, 2,4,3,7,5,6, . . . ,7,6,5,3,2,4, 4,2,3 [symbol] which makes SL(30)≅3.7165 . . . ×10¹⁷. This makes 16SL(30)−1≅5.946 . . . ×10¹⁸ which is too small to encrypt a majority of 64 bit message blocks. This same scenario could happen with either a standard or restricted size element random number sequence.

With either type sequences and defined subsequences like SL= [symbol] 8, 2, [symbol] ₃₀, [symbol] ₂₉ , . . . , [symbol] ₂, [symbol] ₁ [symbol] or [symbol] 16, 2, [symbol] ₃₀, [symbol] ₂₉ , . . . , [symbol] ₂, [symbol] ₁ [symbol] if it is desired to use random sequences and still get some safe and good subsequences, first restrict the sequence elements as above. Then for [symbol] type subsequences, the SL(30) of each potential subsequence may be checked until one is found that satisfies the following two conditions. First SL(30)≧(2⁶⁴)/16≅1.1529 . . . ×10¹⁸ makes the subsequence safe. If safe and also SL(30)≦(2⁶³+1)/2≅9.2233 . . . ×10⁸¹ makes the subsequence good. Thus, to have a both safe and good subsequence the SL(30) satisfies both the inequalities 16SL(30)≧(2⁶⁴) and 2SL(30)+1≦2⁶³ which for 0S8 type simplifies to 2⁶⁰<SL(30)<2⁶². For 16SL type it is 2⁵⁹<SL(30)<2⁶².

There are many sources of random numbers which may be used to generate sequences for use in encryption according to example embodiments. One straightforward source is the string of digits of the decimal part of common irrational numbers, such as square roots of prime numbers. For security, start at some k^{th} place in the decimal expansion and/or use some addend A mod 10 to each digit. To convert any random string to a master sequence take a string of the approximate length of sequence wanted and treat it as a natural number N. For 0S8 type sequences, convert N to base seven and add 2 to each digit. As a simple example if in base ten N=620543, it equals 5163110 in base seven. Adding 2 to each digit makes the sequence [symbol] 7,3,8,5,3,3,2 [symbol] . For 1S6 type sequences convert N to base 15 and add 2 to each digit and so on for other larger types. For the example described above at paragraph 0095, convert N into base six and add 2 to each digit. If an excess of 0 bits is not a problem in pre-encrypting work and a quick safe sequence is desired, for [symbol] type sequences, convert N into base five and add 4 to each digit. This restricts the elements to the small set {4,5,6,7,8}. For 1S6 type sequences, convert N into base thirteen and add 4 to each digit with the element set {4,5,6,7,8,9,10,11,12,13,14,15,16}. Use the same scheme for the larger type sequences. With encryption blocks half the length of message blocks these restricted sequences will be safe, but may not be good.

When using this as a private encryption system or for storage, the encryption process may be modified, for example of use in implementations other than base 2. In addition, other modifications may be used to increase security further. For example, assuming a 64 bit message block of data is to be encrypted, if an encryption block with an odd number of bits is desired both the length of the subsequence and the number of base two digits used to represent the base SL digits are odd. Such an example could use a sequence formed in the same way as the example described above at paragraph 0095. Using 0S8 type sequences and three digit base two representations of the SL base digits, start with the five element block 2,3,4,5,6 instead of six. There are 120 different arrangements of this block so randomly strung together make 600 elements. Place the 1 between two blocks somewhere between the 150^{th} and 450^{th} elements. This example will use 33 element subsequences with indices which are multiples of 5, e.g., SL₅ₖ. Start with 1 on the right followed by six of these five element blocks followed by 4, 5 and then 8. A typical subsequence would be SL= [symbol] 8,5,4, 6,2,5,4,3,5,4,2,3,6,2,4,3,5,6,3,4,5,2,6,4,2,6,5,3,4,6,3,2,5,1 [symbol] which makes SL(30)≅1.3931 . . . ×10¹⁷ which is the 31^{rst} place value. The 32^{nd} place value is 4SL(30), the 33^{rd} place value is 5·4SL(30)=20SL(30), and the 34^{th} place value is 8·5·4SL(30)=160SL(30). Therefore, the maximum number that can be generated is 160SL(30)−1≅2.2290 . . . ×10¹⁹>2⁶⁴ so the subsequences and sequence are safe. Finally the maximum 32 digit number that can be written is 20SL(30)−1≅2.7862 . . . ×10¹⁸2⁶³ so the subsequences and sequences are also good and the encryptions have 33·3=99 bits. If addends are used, they are done in mod 8 in one implementation since three digit base two representations of the SL digits are used in this example.

Hackers can use commonly occurring entries such as “spaces”, “periods”, the single letter “a”, short words like “the”, “if”, “so”, “it”, “of”, etc. or double entries like “cc, tt, nn, oo, cc, ss, rr, etc.” to help break codes. Use of “cyclic addends” can disguise them. In one embodiment, using a 1S6 sequence there are sixteen possible addends (mod 16). Using all or any k>1 element subset of these in any order, every two consecutive encryptions will have different addends so the encryption techniques will be different. This not only makes double entry encryptions different, every message block may be different so every word can have k different encryptions according to one embodiment. In addition to increasing security for double entries, occurrences of common characters, such as periods, would also be encrypted differently in one embodiment.

In one embodiment, a process is to cyclically change the addend after every message block. A small example of a cyclic set [symbol] (k) of k=4 addends such as [symbol] (4)=(3, 14, 2, 5) and a SL subsequence of eight elements are used to illustrate the process in one example. The eight digits of the SL number equivalents of the base two message blocks will be represented in base two with four digits.

Let [symbol] ᵢ be the i^{th} keystroke message block to be encrypted and [symbol] ᵢ(a) be the encryption of the i^{th} keystroke message block with addend “a”. In this example:
[symbol] ₁(3) means an addend of 3 (mod 16) will be added to each of the eight SL digits.
[symbol] ₂(14) means an addend of 14 (mod 16) will be added to each of the eight SL digits.
[symbol] ₃(2) means an addend of 2 (mod 16) will be added to each of the eight SL digits.
[symbol] ₄(5) means an addend of 5 (mod 16) will be added to each of the eight SL digits.
[symbol] ₅(3) means an addend of 3 (mod 16) will be added to each of the eight SL digits.
[symbol] ₆(14) means an addend of 14 (mod 16) will be added to each of the eight SL digits and so on cycling every four entries.

Referring again to the example discussed above starting at paragraph 0048, a 24 bit message block [symbol] =011110100001010111000101 and the subsequence SL= [symbol] 16, 04, 09, 10, 07, 10, 14 13, 1 [symbol] are used to illustrate how one process works with double entries. Recall treating [symbol] as a base two number which equals 8,000,965 in base ten also equals 01 02 08 08 00 01 04 11 in base SL₀. When each of these eight base SL₀ digits is represented in four digit base two form the result is 0001 0010 1000 1000 0000 0001 0100 1011. As a string, this is the encrypted form of [symbol] which is 00010010100010000000000101001011. The double message [symbol] [symbol] encryption would be 000100101000100000000001010010110001001010001 0000000000101001011. Applying a cyclic addend change process with a change set [symbol] =(3, 14, 2, 5), there are four different encryptions of the first message block which all have their first 32 bit string different than the second 32 bit string. Starting with the first two changes 3 and 14 denoted by [symbol] (3) [symbol] (14) the addend 3 (mod 16) encryption for the first [symbol] is calculated by (0001+0011) (0010+0011) (1000+0011) (1000+0011) (0000+0011) (0001+0011) (0100+0011) (1011+0011)=0100 0101 1011 1011 0011 0100 0111 1110 which as a string makes the encryption for this [symbol] (3)=01000101101110110011010001111110. The second [symbol] (14) is calculated by (0001+1110) (0010+1110) (1000+1110) (1000+1110) (0000+1110) (0001+1110) (0100+1110) (1011+1110)=1111 0000 0110 0110 1110 1111 0010 1001 which as a string is the encryption 111100000110011011101 11100101001. Thus the encryption for [symbol] (3) [symbol] (14) is 0100010110111011001101000111111011110000011001101110111100101001

Similarly, [symbol] (2) is calculated by (0001+0010) (0010+0010) (1000+0010) (1000+0010) (0000+0010) (0001+0010) (0100+0010) (1011+0010)=0011 0100 1010 1010 0010 0011 0110 1101 which as a string is the encryption [symbol] (2)=00110100101010100010001101101101.

Similarly, [symbol] (5) is calculated by (0001+0101) (0010+0101) (1000+0101) (1000+0101) (0000+0101) (0001+0101) (0100+0101) (1011+0101)=0110 0111 1101 1101 0101 0110 1001 0000 which as a string is the encryption [symbol] (5)=01100111110111010101011010010000.

The four different encryptions for this double entry are:
[symbol] (3) [symbol] (14)=0100010110111011001101000111111011110000011001101110111100101001
[symbol] (14) [symbol] (2)=1111000001100110111011110010100100110100101010100010001101101101
[symbol] (2) [symbol] (5)=0011010010101010001000110110110101100111110111010101011010010000
[symbol] (5) [symbol] (3)=0110011111011101010101101001000001000101101110110011010001111110

If the addend set was chosen using all sixteen possible addends, there would be 240 different encryptions used for any double entry (16 different encryptions for the first message block and 15 different encryptions for the second message block provides 16×15=240 different encryptions for each double entry in one example.

To decipher or decrypt the encrypted data of a cyclic addended encrypted message, the process described above starting at paragraph 0045 may be reversed. For this example, the encrypted message is broken into 32 bit encryptions and each of them is further broken into 8 four bit blocks. Treat each of these four bit blocks as four digit base two numbers. For the first 32 bit encryption [symbol] (3), subtract the addend 3 (mod 16) from each 4 digit block number. (Note that adding 13

is equivalent to subtracting 3 in mod 16 arithmetic.) These summands are the 8 digits of the SL subsequence number used to encrypt the original message [symbol] ᵢ. This number which is converted to base two and treated as a 24 bit string is the original first message block [symbol] ₁.

The same process is used for each 32 bit encryption in one embodiment. For the second 32 bit encryption [symbol] ₂(14), subtract the addend 14 (mod 16) from each 4 digit block number. This gives the eight digits of the SL subsequence number which converted to base two gives the 24 bit message block of [symbol] ₂.

For the third 32 bit encryption [symbol] ₃(2) subtract 2, for the fourth 32 bit encryption [symbol] ₄(5) subtract 5 and then start recycling the addends. For 32 bit encryptions [symbol] ᵢ(a) with i of the form 4j+1 use addend 3, of form 4j+2 use addend 14, of form 4j+3 use addend 2 and of form 4j use addend 5 in one example.

Another possible change scheme which addresses double message blocks and common entries such as spaces and periods is to change safe SL subsequences. Two examples schemes are described below.

The first is for any given safe master sequence, cyclically change the safe SL subsequences by the same (or a similar) scheme to the one used to change addends as described above in paragraphs 00106-00115.

A second way is for any given safe subsequence SL, such as the example discussed in paragraph 00108 where SL₀= [symbol] 16, 04, 09, 10, 07, 10, 13, 1 [symbol] , the encrypted the 24 bit message [symbol] =011110100001010111000101 which treated as a base 2 number=8,000,965 in base ten and =01 02 08 08 00 01 04 11 in base SL₀. Using B=4, the base 2 form of the digits is 0001 0010 1000 1000 0000 0001 0100 1011 making the encryption [symbol] ₀=00010010100010000000000101001011.

Create a new safe subsequence SL_{0,R}= [symbol] 16, 13, 14, 10, 07, 10, 09, 04, 1 [symbol] by reversing the order of the subsequence elements and leaving the assigned elements 1 and 16 intact. Encrypting [symbol] (8,000,965 in base ten) with SL_{0,R} provides 01 09 09 04 06 09 00 01 in base SL_{0,R}. These eight digits written in base 2 are 0001 1001 1001 0100 0110 1001 0000 0001 making the SL_{0,R} encryption [symbol] _{0,R}=00011001100101000110100100000001. Double messages and common entries are disguised by alternating back and forth between the subsequences SL₀ and SL_{0,R} in one embodiment.

In one embodiment, a reverse safe subsequence is formed from a safe reversible subsequence SL= [symbol] aⱼ, aⱼ₋₁ . . . , a₁, sₖ, sₖ₋₁, . . . , s₂, s₁,1 [symbol] where the a₂ elements and the number 1 are assigned and the s, elements are from the subsequence with s₁≧sₖ (this example restriction insures SL_{R} will also be safe). The new safe subsequence SL_{R} is created by just reversing the order of the sᵢ sequence elements and leaving the assigned aᵢ elements intact. Thus, SL_{R}= [symbol] (aⱼ,aⱼ₋₁ . . . , a₁, s₁, s₂, . . . sₖ₋₁, sₖ,1 [symbol] in the described embodiment.

Other possible security code change schemes can be devised such as the following examples.

In one embodiment, users communicating together (transmission and reception) understand the basic encryption system and are securely informed about starting data of the encryption bases being used before each communication, including encryption parameters of the encryption bases and encryption processes, such as message block size, [symbol] sequence, [symbol] ₀ sequence and the [symbol] subsequence, addend, the size of the base two conversion of the [symbol] digits, and schemes for how to change encryption parameters if and when you want. Any or all of these encryption parameters can be changed between (or even within) large messages in example embodiments making it literally impossible to decrypt.

An additional challenge is finding simple secure ways to inform the users of this data regarding the parameters of the encryption and processes being utilized. An example method of securely informing users of information regarding encryption parameters includes use of a two digit (or other) numerical code to change subsequences and addends. In one embodiment, this information may be communicated using networks, wired or wireless communications, memory storage devices transferred between devices, or using other appropriate methods or apparatus.

For simplicity, the following example is in base ten and encrypting is done with an [symbol] type sequence, and it is desired to change the [symbol] ᵢ's, addends and perhaps other encryption parameters after every message block. One scheme to change both would be to use a first digit (3, 4, 5 or 6) of a change code to indicate the amount of the initial or first change of the subsequence by moving the 1 in the sequence 3, 4, 5, or 6 elements to the right. This also determines the start of a ± alternating of changes. The second digit (2, 3 or 4) determines the amount of change for subsequent changes after the initial or first change. The specified changes alter the placement of the “1” in the initial sequence providing different master sequences which may be used to generate the different subsequences of the different encryption bases as discussed above.

For example, a [symbol] ᵢ change code 43 would start the first message with [symbol] ₀ and change to [symbol] ₄ for the next message in accordance with the first digit being 4. From then on after each message, change the [symbol] ᵢ index by −((−1)ⁿ)3n which alternates multiples of 3 according to the second digit being 3 and starting with + since the 4 in code 43 is even which instructs starting with + in this example. This makes the index change: +3·1, −3·2, +3·3, −3·4, +3]5, −3·6, . . . giving consecutive [symbol] indices of 0, 4, (4+3=7), (7−6=1), (1+9=10), (10−12=−2), (−2+15=13), (13−18=−5),ⁿ . . . . Thus, the [symbol] indices would change between the encryption of each message block from 0 to 4, to 7, to 1, to 10, to −2, to 13, to −5, . . . in this example.

The same scheme with a [symbol] ᵢ change code of 32 would again start the first message with [symbol] ₀ and change to [symbol] ₃ and from there on change the [symbol] index by (−1)ⁿ)2n which alternates multiples of 2 starting with − since the 3 in code 32 is odd instructs starting with −. This makes the index changes: −2·1, +2·2, −2·3, +2·4, −2·5, +2·6,), . . . giving consecutive [symbol] indices of 0, 3, (3−2=1), (1+4=5), (5−6=−1), (−1+8=7), (7−10=−3), (−3+12=9), “ . . . so the [symbol] indices would change between each message from 0 to 3, to 1, to 5, to −1, to 7, to −3, to 9, . . . in this example.

The same scheme with a change code of doubles (33, 44, or . . . ) would mean make no changes in one embodiment.

In one embodiment, addends are changed by making the addends the [symbol] index number mod 16 (or whatever other sequence type length is being used) in one example. Thus, code 32 for the change code above makes the addends mod 16 change be: 0 to 3 to 1 to 5 to (−1=15) to 7 to (−3=13) to 9 to . . . .

A benefit of this example change scheme is that many changes can be made keeping all indices between 20 and 20 in one embodiment. All the data needed for these 41 different change codes would be 41 small subsequences in one implementation which could be generated by the master computer and sent to all the other users ahead of communications having encrypted data content.

In one embodiment, a sample ten digit numerical instruction to users for encrypting 64 bit blocks to 128 bit blocks with a pre-agreed interval for change could be: 4567407643. The first five symbols identify the sequence type and some encrypting details in one example implementation. More specifically, the first symbol 4 identifies the maximum size sequence element as (2⁴) or type 1S6, the second symbol 5 identifies the sequence as sequence number 5 of this type, the third symbol 6 identifies the message block size as 2⁶=64 bits, the next symbol 7 identifies the encrypted block size as 2⁷=128 bits, and the fifth symbol 4 identifies that each [symbol] digit is written in a 4 digit base two form in this described embodiment. The second five symbols identify the starting [symbol] ᵢ, addends and change schemes in this embodiment. The first three symbols 076 identify [symbol] ₀, as S₀₇₆ and the last two symbols 43 identify the [symbol] ₁'s and addends change code as 43 in this illustrative example. Other change schemes and variations are left up to the skills and imagination of system designers and programmers. In one embodiment, a plurality of different initial sequences may be designed and communicated to the participants for future use. The initial sequences are communicated in a secure manner (e.g., mail, hand delivery, etc.) and may be selected by an instruction before encryption is commenced in one embodiment.

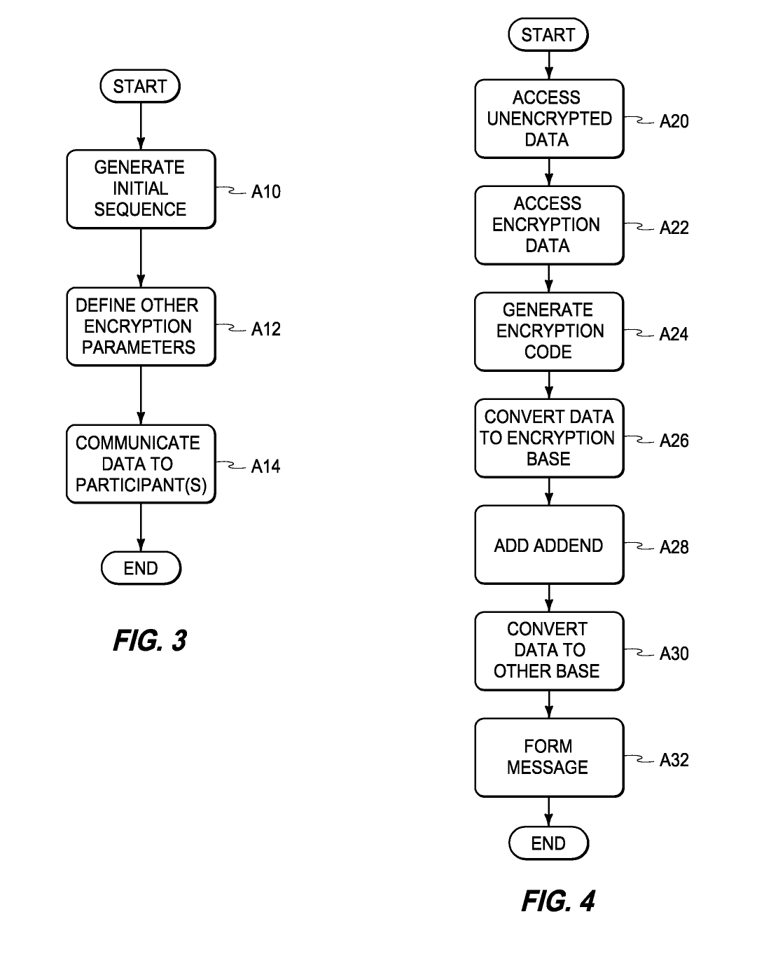

Referring to FIG. 3, an example process of configuring a plurality of participants, such as the above-described data sender and data receiver, to communicate encrypted data with respect to one another is shown. Processing circuitry of one or more of the participants are used to implement the illustrated method in one embodiment. Other methods are possible including more, less and/or alternative acts.

At an act A10, one of the participants may generate an initial sequence which will be used to generate different master sequences and different subsequences as previously described. The initial sequence may be randomly generated and chosen to meet the safe and good criteria discussed above.

At an act A12, other parameters for the encryption are selected and which may be varied to provide increased security and encryption of the data in addition to varying of the master sequences and the subsequences which are used for the encryption.

At an act A14, the data regarding the initial sequence and parameters for the encryption which will be used for subsequent encrypted communications is communicated to the participants, such as the data sender and/or data receiver.

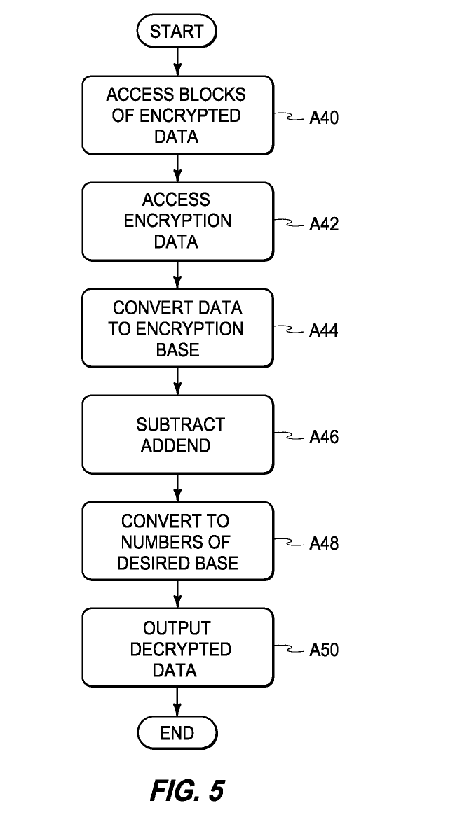

Referring to FIG. 4, an example process for encrypting data is shown. Processing circuitry of a data sender participant is used to implement the illustrated method in one embodiment. Other methods are possible including more, less and/or alternative acts.

At an act A20, the unencrypted data which is to be encrypted is accessed. In one embodiment, a plurality of message blocks of the unencrypted data are created which individually include a plurality of bits which correspond to a single keystroke of an input device.

At an act A22, the encryption data including the initial sequence and other parameters which are to be used for the encryption are accessed.

At an act A24, a master sequence and subsequence are generated using the initial sequence and the specified encryption parameters.

At an act A26, the data to be encrypted is provided in an initial base, such as base 2. A subsequence is used to convert the data from the initial base to the encryption base. A plurality of different conversions are possible and a specific conversion, for example, using a selected one of a plurality of different subsequences is performed in one embodiment.

At an act A28, an addend is added to the digits in the encryption base numbers to provide an improved balance of 0s and ls which provides additional encryption and increased security of the data as discussed above.

At an act A30, the digits in the encryption base numbers are converted to another base, such as base 2, to facilitate use with digital computing systems. A plurality of different conversions are possible, for example, using different numbers of base 2 digits to convert base SLᵢ digits to base two form and which provides additional security and encryption of the data.

At an act A32, a message is formed, for example, in a plurality of message blocks which correspond to a plurality of keystrokes of an input device. The message blocks may each be encrypted using different encryption parameters in one implementation. The encrypted message including the encrypted message blocks may be communicated from a data sender to a data receiver in one embodiment.

Referring to FIG. 5, an example process for decrypting data is shown. Processing circuitry of a data receiver participant is used to implement the illustrated method in one embodiment. Other methods are possible including more, less and/or alternative acts.

At an act A40, the encrypted data including the encrypted message blocks to be decrypted in one embodiment are accessed.

At an act A42, the encryption data including the initial sequence and other parameters which were used to encrypt the data are accessed.

At an act A44, the encrypted data is converted from an initial base base 2 to the encryption base using the appropriate subsequence which decrypts the data.

At an act A46, the appropriate addend is subtracted from the digits in the encryption base number, making the digits of the initial encrypted number.

At an act A48, the data is converted from the encryption base to base 2 to decrypt the data and to facilitate use of the decrypted data in digital computing systems in one embodiment.

At an act A50, the decrypted data may be outputted, for example, using a display device.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended aspects appropriately interpreted in accordance with the doctrine of equivalents.

Further, aspects herein have been presented for guidance in construction and/or operation of illustrative embodiments of the disclosure. Applicant(s) hereof consider these described illustrative embodiments to also include, disclose and describe further inventive aspects in addition to those explicitly disclosed. For example, the additional inventive aspects may include less, more and/or alternative features than those described in the illustrative embodiments. In more specific examples, Applicants consider the disclosure to include, disclose and describe methods which include less, more and/or alternative steps than those methods explicitly disclosed as well as apparatus which includes less, more and/or alternative structure than the explicitly disclosed structure.

What is claimed is:

1. An encryption method comprising:
accessing a sequence of an encryption base, the sequence comprising a plurality of sequence elements which correspond to different place values of the encryption base;
accessing data to be encrypted; and
using the sequence elements of the sequence, encrypting the data by converting the data from an initial base to the encryption base.

2. The method of claim 1 further comprising generating the sequence.

3. The method of claim 2 wherein the generating comprises generating the sequence using a master sequence.

4. The method of claim 3 further comprising randomly generating the master sequence.

5. The method of claim 3 wherein the sequence comprises a subsequence of the master sequence.

6. The method of claim 5 wherein the subsequence comprises a first subsequence, and further comprising:
generating a plurality of different subsequences using the master sequence; and
encrypting the data using the different subsequences.

7. The method of claim 6 wherein the different subsequences correspond to different encryption bases and individually include a plurality of different sequence elements which correspond to different place values of the respective encryption base.

8. The method of claim 7 further comprising encrypting the data from the initial base to the different encryption bases using the different subsequences.

9. The method of claim 3 further comprising generating the master sequence using an initial sequence, and wherein the master sequence includes only a single occurrence of the number 1.

10. The method of claim 9 wherein the initial sequence comprises the sequence elements [symbol] s₂, s₂, . . . , s₂ₖ, s₂ₖ₊₁ . . . s_{4K} [symbol] with the sequence elements constrained by 2≦sⱼ≦2ⁿ for some n≧3.

11. The method of claim 9 further comprising:
moving the number 1 to generate a plurality of additional master sequences; and
encrypting the data using the additional master sequences.

12. The method of claim 11 wherein the initial sequence comprises a plurality of numbers in an order, and the moving comprises moving the 1 to different places in the order of the numbers.

13. The method of claim 3 wherein the master sequence is one of a plurality of different sequence types which include sequence elements of different maximum sizes.

14. The method of claim 1 wherein the sequence elements are a plurality of natural numbers in an order, and wherein the sequence includes only a single occurrence of the number 1.

15. The method of claim 14 wherein the natural numbers are constrained within a defined range.

16. The method of claim 1 further comprising, after the encrypting, converting the data from the encryption base to another base.

17. The method of claim 16 further comprising selecting one of a plurality of different conversions for the converting.

18. The method of claim 17 wherein the different conversions use different numbers of digits to represent the data in the another base.

19. The method of claim 1 further comprising increasing a balance of a plurality of different binary values of the encrypted data.

20. The method of claim 19 wherein the increasing comprises increasing by adding an addend to the encrypted data.

21. The method of claim 20 further comprising changing the addend at different times to provide additional encryption of the data.

22. The method of claim 1 wherein a message block includes data corresponding to a keystroke from a keyboard input device, and further comprising changing one or more parameters of the encrypting after the encrypting the data corresponding to the keystroke.

23. The method of claim 1 wherein encrypting comprises converting a plurality of digits of the initial base to a plurality of digits of the encryption base.

24. A non-transitory computer readable medium comprising programming configured to cause processing circuitry to implement the method of claim 1.

25. An encryption method comprising:
accessing data to be encrypted;
providing a sequence of a plurality of numbers in an order, wherein the sequence includes only a single occurrence of the number 1;
moving the number 1 within the sequence a plurality of times to generate a plurality of different encryption bases; and
encrypting the data using different ones of the encryption bases.

26. A non-transitory computer readable medium comprising programming configured to cause processing circuitry to implement the method of claim 25.
